(19) United States
(12) Patent Application Publication
(10) Pub. No.: US 2026/0208817 A1
(43) Pub. Date: Jul. 23, 2026

(54) Structural Element for a Single- Or Dual-Track Motor Vehicle, More Particularly for a Motorcycle, Single- Or Dual-Track Motor Vehicle, and Method for Producing Such a Structural Element

(71) Applicant: Bayerische Motoren Werke Aktiengesellschaft, Muenchen (DE)

(72) Inventors: Simon LEHRICH, Hildesheim (DE); Marcus MUND, Muenchen (DE)

(21) Appl. No.: 19/140,230

(22) PCT Filed: Feb. 15, 2024
(86) PCT No.: PCT/EP2024/053793

§ 371 Date: Jun. 17, 2025

(30) Foreign Application Priority Data
Mar. 7, 2023 (DE) 10 2023 105 503.8

(51) Int. Cl. B62K 25/04

(52) U.S. Cl. CPC B62K 25/04

(57) ABSTRACT

A structural element is provided for a single- or dual-track motor vehicle. The structural element includes at least one rheocast component made of a metallic material.

### BACKGROUND AND SUMMARY

The invention relates to a structural element for a single- or dual-track motor vehicle, in particular for a motorcycle. The invention also relates to a single- or dual-track motor vehicle having at least one such structural element. The invention also relates to a method for producing a structural element for a single- or dual-track motor vehicle, in particular for a motorcycle.

U.S. Pat. No. 9,598,132 B2 discloses a frame structure for an electric motorcycle. EP 2 589 528 A1 also discloses a motorcycle having a frame and a motor fastened to the frame.

The object of the present invention is to create a structural element for a single- or dual-track motor vehicle, a single- or dual-track motor vehicle having at least one such structural element, and a method for producing such a structural element so that a particularly low weight and advantageous mechanical properties of the structural element can be realized.

This object is achieved according to the invention by a structural element, by a single- or dual-track motor vehicle having such a structural element, and by a method, in accordance with the independent claim(s). Advantageous embodiments form the subject matter of the dependent claims.

A first aspect of the invention relates to a structural element for a single- or dual-track motor vehicle. This means that the single- or dual-track motor vehicle has the structural element when in its fully produced state. Preferably, the single- or dual-track motor vehicle is a single-track motor vehicle having exactly two vehicle wheels, which are arranged one behind the other, i.e., following one another, in the vehicle longitudinal direction of the motor vehicle. The single- or dual-track motor vehicle can thus be, for example, a single-track motorcycle with exactly two vehicle wheels, which are arranged one behind the other, in particular following one another, in particular in the vehicle longitudinal direction of the motorcycle. It is also contemplated for the single- or dual-track motor vehicle to be a three wheeler, in particular a dual-track three wheeler, therefore a motor vehicle, in particular a dual-track motor vehicle, having exactly three vehicle wheels, and therefore the single- or dual-track motor vehicle can be, for example, in the form of a motorcycle with sidecar or else in the form of a tricycle.

The structural element in particular means a load-bearing component. The structural element contains a metallic material. For example, the metallic material is a light metal, i.e., a light metal alloy, in particular an aluminum alloy.

In order to be able to realize a particularly low weight and at the same time particularly advantageous mechanical properties of the structural element, it is provided according to the invention for the structural element to have at least one rheocast component formed from the metallic material. The rheocast component, which is also referred to as first rheocast part, means a component that is produced by rheocasting, i.e., by a rheocasting method. Rheocasting is a casting method in which the metallic material as a casting material is processed in a semisolid or semiliquid state instead of in a completely liquid state. In rheocasting, for example, an initially completely solid raw workpiece is provided, which is formed from the metallic material but from which a liquid melt is not produced, but rather the raw workpiece, which is also referred to as a blank, is electromagnetically kneaded, so to speak, therefore processed by electromagnetic waves, so that the raw workpiece changes into the aforementioned semisolid or semiliquid state, therefore into a state similar to jelly or cooled ice cream. In this state, the blank is pressed into a die or mold, for example by means of a plunger like in a diecasting method, and thereby shaped, as a result of which the rheocast component is produced from the blank. Particularly small wall thicknesses of the rheocast component can thereby be realized, and the same or even better material properties can be realized in comparison with conventional components. As a result, the weight of the structural element can be kept particularly low overall, and particularly advantageous mechanical properties of the structural element can be produced. In particular, wall thicknesses can be realized that are at most 3.5 millimeters or even less than 3.5 millimeters, wherein particularly advantageous mechanical properties are realized at the same time.

In order to be able to keep the weight of the structural element particularly low and to realize particularly advantageous mechanical properties of the structural element, it is provided in one embodiment of the invention for at least 30 percent of a volume and/or a mass of the structural element to be formed by the rheocast component.

A further embodiment is characterized in that the structural element is designed as a frame of the single- or dual-track motor vehicle. This embodiment is based on the finding that the frame of a single- or dual-track motor vehicle makes a critical contribution to the total weight of the single- or dual-track motor vehicle, and therefore the weight of the single- or dual-track motor vehicle can be kept particularly low by designing the structural element as a frame.

In a further, particularly advantageous embodiment of the invention, the structural element is designed as a rear swingarm for the single- or dual-track motor vehicle. A rear swingarm of a single- or dual-track motor vehicle can also make a critical contribution to the total weight of the single- or dual-track motor vehicle, and therefore the weight of the single- or dual-track motor vehicle can be kept particularly low by the invention. Therefore, for example, in the fully produced state of the single- or dual-track motor vehicle, one of the aforementioned vehicle wheels of the single- or dual-track motor vehicle is designed as a rear wheel, in particular a single rear wheel, of the single- or dual-track motor vehicle and is held rotatably on the rear swingarm. In particular, unsprung masses of the single- or dual-track motor vehicle can thereby be kept particularly low.

In order to be able to realize particularly advantageous properties of the rheocast component and thus of the structural element overall in a particularly favorable manner in terms of weight, it is provided in a further embodiment of the invention for the rheocast component to have at least or exactly one rib to reinforce the rheocast component.

In a further, particularly advantageous embodiment of the invention, the structural element has the first rheocast component and at least or exactly one second rheocast component, which is provided in addition to the first rheocast component, is formed separately from the first rheocast component and is connected, in particular directly, to the first rheocast component. Very preferably, the structural element has exactly two rheocast components, specifically the first rheocast component and the second rheocast component. A low weight and particularly advantageous mechanical properties of the structural element can thus be realized. Moreover, the structural element can thereby be produced quickly and inexpensively according to demand. The statements made above and below in relation to the first rheocast component can also readily be applied to the second rheocast component, and vice versa.

The rheocast components are connected to one another, in particular directly, in a form-fitting and/or integrally bonded and/or form-fitting manner.

It has proven particularly advantageous when the rheocast components are welded to one another, in particular directly, and thereby connected to one another, in particular directly. Particularly advantageous properties of the structural element can thereby be achieved in a particularly favorable manner in terms of weight and costs.

It is also contemplated for the rheocast components to be screw-fastened to one another.

It is particularly advantageous when the rheocast components are adhesively bonded to one another, in particular directly, and thereby connected to one another, in particular directly.

Finally, it has proven particularly advantageous when the rheocast components per se, i.e., considered by themselves, form a hollow cross section, in particular an open hollow cross section, having at least or exactly one opening, so that the hollow cross section is open on a side on which the opening is arranged. The opening, which is designed in particular as a through-opening, is closed at least predominantly and thus at least by more than half, in particular completely, by a closing element, which is formed separately from the rheocast components, is provided in addition to the rheocast components and is connected, in particular welded and/or adhesively bonded and/or screw-fastened, in particular directly, to the rheocast components. A particularly high stiffness can thereby be realized in a particularly favorable manner in terms of weight.

The closing element can be formed integrally, therefore as a single piece. This means that the closing element is not composed of multiple parts that are formed separately from one another and connected to one another, but the closing element is formed from a single piece and thus is designed as a monobloc or is formed by a monobloc. Alternatively, the closing element may be of multi-part design, so that the closing element has, for example, multiple, i.e., at least or exactly two parts, which are formed separately from one another and are connected to one another, in particular welded and/or adhesively bonded and/or screw-fastened to one another, in particular directly, and is formed from the parts.

In order to be able to realize particularly advantageous mechanical properties of the structural element in a particularly favorable manner in terms of costs and weight, it is provided in a further embodiment of the invention for the rheocast components not to be mirror-symmetrical to one another.

Preferably, the closing element is designed as a component different from a rheocast component, so that the closing element is preferably not produced by rheocasting. Preferably, the closing element is formed from the aforementioned metallic material or from another, further metallic material, in particular from a steel or a steel alloy. The closing element can be formed from a light metal alloy, in particular an aluminum alloy. For example, the rheocast component is designed as a sheet metal component, which is in particular different from a rheocast component.

A second aspect of the invention relates to a single- or dual-track motor vehicle that has at least one structural element according to the first aspect of the invention. Advantages and advantageous embodiments of the first aspect of the invention can be regarded as advantages and advantageous embodiments of the second aspect of the invention, and vice versa.

A third aspect of the invention relates to a method for producing a structural element for a single- or dual-track motor vehicle, which is also simply referred to as vehicle or motor vehicle. In the method according to the third aspect of the invention, the structural element is produced from a metallic material.

In order to be able to realize particularly advantageous mechanical properties and a particularly low weight of the structural element, it is provided in the third aspect of the invention for the structural element to be produced by rheocasting. Advantages and advantageous embodiments of the first and second aspects of the invention can be regarded as advantages and advantageous embodiments of the third aspect of the invention, and vice versa.

Further details of the invention can be found in the following description of preferred exemplary embodiments with the associated drawings.

### BRIEF DESCRIPTION OF DRAWINGS

FIG. 1 is a schematic perspective view of a first embodiment of a structural element in the form of a rear swingarm for a single- or dual-track motor vehicle;

FIG. 2 is a further schematic perspective view of the structural element according to the first embodiment;

FIG. 3 is a further schematic perspective view of the structural element according to the first embodiment; and

FIG. 4 is a schematic side view of a second embodiment of the structural element.

In the figures, identical or functionally identical elements are provided with the same reference signs.

### DETAILED DESCRIPTION OF DRAWINGS

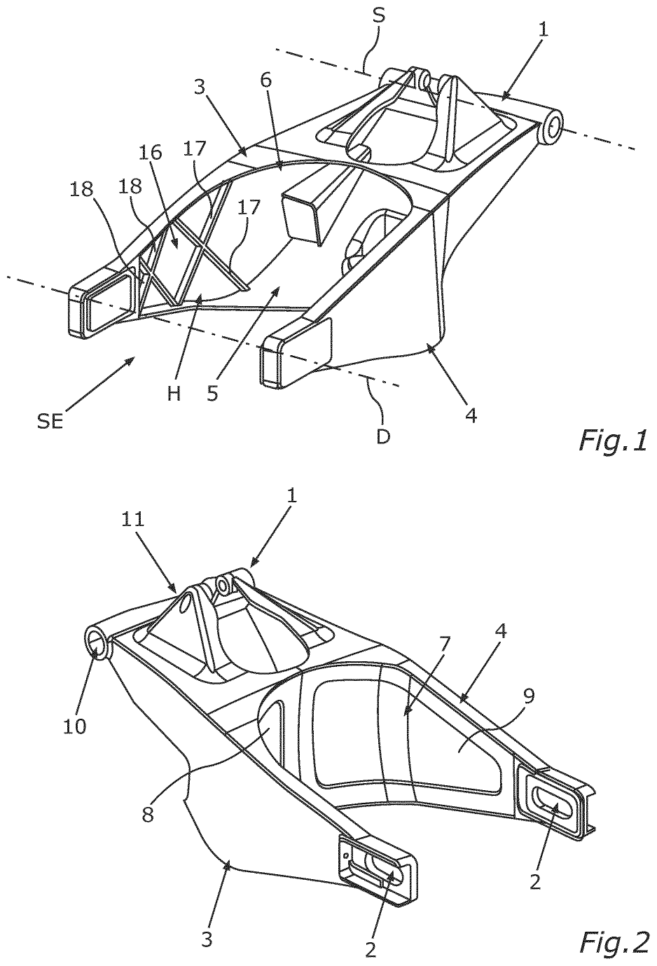

FIG. 1 shows a detail, in a schematic perspective view, of a first embodiment of a structural element in the form of a rear swingarm 1 for a single- or dual-track motor vehicle. This means that the single- or dual-track motor vehicle has the rear swingarm 1 when in its fully produced state. The single- or dual-track motor vehicle, which is also referred to as vehicle or motor vehicle, is, for example, a land vehicle in the form of a single-track motorcycle, so that preferably the motor vehicle has exactly two vehicle wheels. The vehicle wheels of the single- or dual-track motor vehicle are also referred to simply as wheels and are arranged one behind the other, i.e., following one another, in the vehicle longitudinal direction of the motor vehicle. The vehicle wheels are ground contact elements via which the single- or dual-track motor vehicle can be supported or is supported downward on the ground in the vehicle vertical direction of the single- or dual-track motor vehicle. If the single- or dual-track motor vehicle is driven along the ground while the single- or dual-track motor vehicle is supported downward on the ground via the ground contact elements in the vehicle vertical direction of the single- or dual-track motor vehicle, the ground contact elements roll, in particular directly, on the ground. The single- or dual-track motor vehicle has a frame, which is formed separately from the rear swingarm 1 and to which, for example, a drive motor of the single- or dual-track motor vehicle is connected. The rear swingarm 1 is also referred to simply as swingarm and, for example, is mounted on the frame pivotably about a pivot axis S relative to the frame. Furthermore, the single- or dual-track motor vehicle has, for example, a fork, which is formed separately from the swingarm and separately from the frame and is mounted on the frame pivotably about a steering axis relative to the frame. A first of the vehicle wheels is a front wheel of the single- or dual-track motor vehicle, the front wheel of which is held rotatably on the fork. A second of the vehicle wheels is a rear wheel of the single- or dual-track motor vehicle, the rear wheel of which is held on the swingarm rotatably relative to the swingarm, about a wheel rotational axis D, which is shown by way of example in FIG. 1. The rear wheel can pivot together with the swingarm about the pivot axis S relative to the frame, and the front wheel can be pivoted together with the fork about the steering axis relative to the frame. By pivoting the fork and the front wheel relative to the frame and about the steering axis, the front wheel and thus the single- or dual-track motor vehicle can be steered, as a result of which curves, changes in driving direction and lane changes of the single- or dual-track motor vehicle can be carried out, in particular while the single- or dual-track motor vehicle is traveling.

It can be seen in FIG. 2 that the swingarm has, for example, two through-openings 2, which in particular align with one another and which are, for example, penetrated by an axle. The rear wheel is, for example, mounted rotatably on the axle, so that the rear wheel is mounted on the axle and thus on the rear swingarm 1 rotatably about the wheel rotational axis D relative to the axle and relative to the rear swingarm 1. Each through-opening 2 is designed as a slot, the longitudinal extension direction of which runs in the vehicle longitudinal direction of the single- or dual-track motor vehicle. A distance running in the vehicle longitudinal direction between the vehicle wheels and thus a so-called wheel base of the single- or dual-track motor vehicle can thereby be adjusted, i.e., varied.

In order then to be able to realize a particularly low weight and particularly advantageous mechanical properties of the rear swingarm 1, the rear swingarm 1 has exactly two rheocast components, specifically a first rheocast component 3 and a second rheocast component 4. The rheocast components 3 and 4 are formed separately from one another and are connected directly to one another, in the present case such that the rheocast components 3 and 4 are welded directly to one another. Each rheocast component 3, 4 is formed from a metallic material. Preferably, the metallic material is a light metal alloy, in particular an aluminum alloy. In the first embodiment, at least 30 percent of a volume and/or a mass of the rear swingarm 1, considered as a whole, are formed by each rheocast component 3, 4, so that, for example, the rheocast components 3 and 4 in total, i.e., considered together, form at least 60 percent of the volume and/or the mass of the rear swingarm 1 overall.

In the first embodiment, each rheocast component 3, 4 is designed as a shell element, also referred to simply as shell, so that each rheocast component 3, 4 is designed as a rheocast shell. Each shell per se, i.e., considered by itself, has an open hollow cross section H, wherein the rheocast components 3 and 4 are assembled, i.e., connected to one another, such that the hollow cross sections H of the shells face one another. The rheocast components 3 and 4 per se, i.e., considered by themselves, form or delimit a hollow cross section 5, which is also referred to as total hollow cross section and has at least one opening 6 in the form of a through-opening, as a result of which the hollow cross section 5 per se, i.e., considered by itself, is open toward the rear on a side SE facing rearward in the vehicle longitudinal direction of the motor vehicle and thus in the vehicle longitudinal direction of the single- or dual-track motor vehicle. In the fully produced state of the single- or dual-track motor vehicle, the side SE faces the rear wheel, so that the hollow cross section 5 per se, i.e., considered by itself, is open toward the rear wheel.

It can be seen in FIG. 2 that in the first embodiment the hollow cross section 5 is closed by a closing element 7, which is formed separately from the rheocast components 3 and 4, is provided in addition to the rheocast components 3 and 4 and in the present case is connected directly to the rheocast components 3 and 4. In the first embodiment, the closing element 7 is a closing plate and therefore is designed as a sheet metal part. In particular, the closing element 7 is formed from steel or from the aforementioned light metal alloy, in particular aluminum alloy, or from another, further light metal alloy, in particular further aluminum alloy, that is different from the aforementioned light metal alloy. In the first embodiment, the closing element 7 has a multi-part design, wherein the closing element 7 has, in particular exactly, two closing parts 8 and 9. The closing parts 8 and 9 are formed separately from one another and are connected to one another, in particular welded to one another, in particular directly. In particular, the closing element 7 is welded, in particular directly, to the rheocast components 3 and 4 and thereby connected, in particular directly, to the rheocast components 3 and 4. It can be seen in FIGS. 1 and 2 that the rheocast components 3 and 4 in the form of rheocast shells, the inner sides of which face one another, are welded to one another, in particular directly, and thereby connected to one another, in particular directly, on their inner sides and thereby form the hollow cross section 5, which is open toward the rear wheel and is closed at least predominantly and thus at least by more than half, in the present case completely, by the closing element 7. In particular, a high torsional and bending stiffness of the rear swingarm 1 can thereby be realized in a particularly favorable manner in terms of weight. Preferably, the rheocast components 3 and 4 are not mirror-symmetrical to one another.

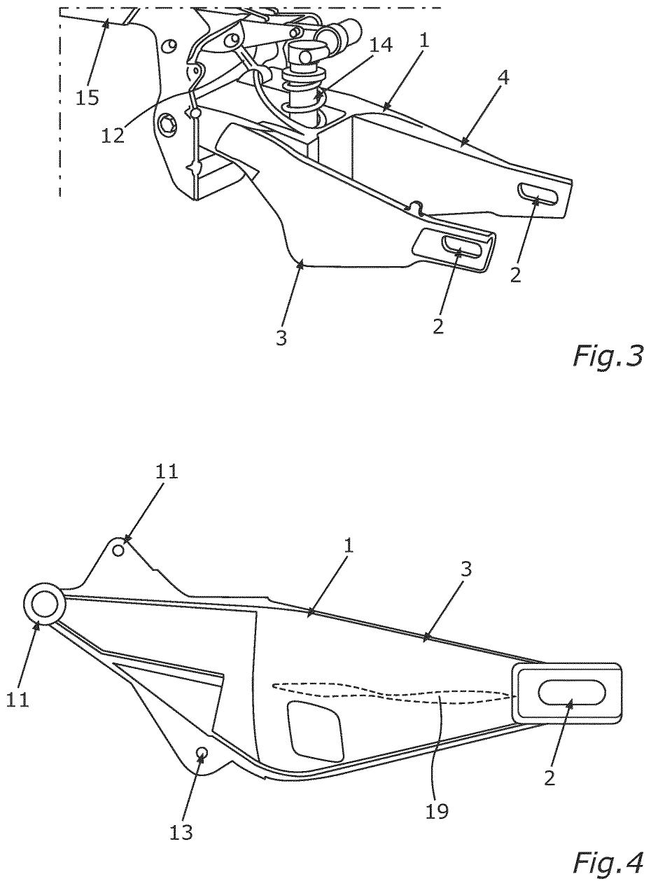

The rear swingarm 1 has a first bearing point 10, via which the rear swingarm 1 is to be mounted or is mounted on the frame pivotably about the pivot axis S relative to the frame. The bearing point 10 is formed partially by the rheocast component 3 and partially by the rheocast component 4. Furthermore, the rear swingarm 1 has a first attachment device 11, which is formed partially by the rheocast component 3 and partially by the rheocast component 4. By means of the attachment device 11, a push rod 12, which can be seen in FIG. 3 and is formed separately from the rear swingarm 1, is attached to the rear swingarm 1, in particular in an articulated manner, in the present case, for example, such that the push rod 12 is mounted on the rear swingarm 1 rotatably about a rotational axis relative to the rear swingarm 1. For example, the rotational axis runs parallel to the pivot axis S. Furthermore, the rear swingarm 1 has a second attachment device 13, which can be seen in FIG. 4 and is formed, for example, partially by the rheocast component 3 and partially by the rheocast component 4. By means of the attachment device 13, a spring and/or damper element 14 of the single- or dual-track motor vehicle is attached to the rear swingarm 1, in particular in an articulated manner, in particular such that the spring and/or damper element 14 is mounted on the rear swingarm 1 rotatably about a second rotational axis relative to the rear swingarm 1. For example, the rotational axes run parallel to one another, wherein preferably the rotational axes are spaced from one another. Moreover, the second rotational axis is spaced from the pivot axis S and the wheel rotational axis D, and the first rotational axis is spaced from the pivot axis S and the wheel rotational axis D.

In the exemplary embodiment shown in FIG. 3, the spring and/or damper element 14 is a suspension strut. The rear swingarm 1 is supported on the frame in a sprung and/or damped manner via the spring and/or damper element 14 such that pivoting movements of the rear swingarm 1 and thus of the rear wheel about the pivot axis S and relative to the frame are sprung and/or damped by means of the spring and/or damper element 14. In particular, for example, compressive forces emanating from the rear swingarm 1 can be transmitted via the push rod 12 to the spring and/or damper element 14, as a result of which, for example, the spring and/or damper element 14 can be compressed. In FIG. 3, a detail of the aforementioned frame of the single- or dual-track motor vehicle can be seen and is denoted by 15 in FIG. 3.

It can be seen in FIG. 1 that each rheocast component 3, 4 can have a rib structure 16, in particular on its inner side. In the first embodiment, the rib structure 16 has multiple ribs, wherein at least two of the ribs intersect. In the first embodiment, two first ribs intersect, and two second ribs intersect, wherein the intersecting first ribs are denoted by 17, and the intersecting second ribs are denoted by 18. The ribs 17 form a first rib pair, and the ribs 18 form a second rib pair, wherein the rib pairs are arranged following one another in the vehicle longitudinal direction of the motor vehicle. Each rheocast component 3, 4 is reinforced by means of the ribs 17 and 18 and thus by means of the rib structure 16, so that a particularly high stiffness of each rheocast component 3, 4 and thus of the rear swingarm 1 can be ensured in a favorable manner in terms of weight and installation space.

FIG. 4 shows a second embodiment of the rear swingarm 1 in a schematic side view. It can be seen from the example of the rheocast component 3 that the second embodiment differs from the first embodiment in particular in that each rheocast component 3, 4 has, for example, in particular exactly, one rib 19 on its inner side, by means of which rib each rheocast component 3, 4 is reinforced. The rib 19 extends at least substantially in the vehicle longitudinal direction of the single- or dual-track motor vehicle, and therefore the rib 19 is a longitudinal rib. It can be seen overall that the rib 19 or the rib structure 16 is a ribbing or is also referred to as a ribbing, wherein each rheocast component 3, 4 is reinforced by the corresponding ribbing. It can also be seen that each rheocast component 3, 4 is a cast shell, which is produced by rheocasting, i.e., by a rheocasting method. Advantageously small wall thicknesses of each rheocast component 3, 4 can thereby be realized, and particularly advantageous material properties of each rheocast component 3, 4 can be achieved.

### List of Reference Signs

1 Rear swingarm
2 Through-opening
3 Rheocast component
4 Rheocast component
5 Hollow cross section
6 Opening
7 Closing element
8 Closing part
9 Closing part
10 Bearing point
11 First attachment device
12 Push rod
13 Second attachment device
14 Spring and/or damper element
15 Frame
16 Rib structure
17 First rib
18 Second rib
19 Rib
D Wheel rotational axis
H Hollow cross section
S Pivot axis
SE Side

1.-10. (canceled)

11. A structural element for a single- or dual-track motor vehicle, comprising:
at least one rheocast component formed from a metallic material, wherein the at least one rheocast component is part of the structural element.

12. The structural element according to claim 11, wherein
at least 30% of a volume and/or a mass of the structural element are formed by the at least one rheocast component.

13. The structural element according to claim 11, wherein
the structural element is configured as a frame for the single- or dual-track motor vehicle.

14. The structural element according to claim 11, wherein
the structural element is configured as a rear swingarm for the single- or dual-track motor vehicle.

15. The structural element according to claim 11, wherein
the at least one rheocast component comprises at least one rib configured to reinforce the rheocast component.

16. The structural element according to claim 11, further comprising:
a second rheocast component, which is provided in addition to the first rheocast component, wherein
the first and second rheocast components are formed separately and are connected to one another.

17. The structural element according to claim 16, wherein
the first and second rheocast components are welded and/or adhesively bonded to one another.

18. The structural element according to claim 16, wherein
the first and second rheocast components form a hollow cross section having at least one opening, which is closed at least predominantly by a closing element, which closing element is formed separately from the first and second rheocast components, is provided in addition to the first and second rheocast components, and is connected to the first and second rheocast components.

19. A single- or dual-track motor vehicle comprising at least one structural element according to claim 11.

20. A method for producing a structural element for a single- or dual-track motor vehicle, the method comprising:
providing a metallic material from which the structural element is to be produced; and
rheocasting at least one component of the structural element.
